(19) United States
(12) Patent Application Publication
(10) Pub. No.: US 2017/0288923 A1
(43) Pub. Date: Oct. 5, 2017

(54) CARRIER-SENSING METHOD

(71) Applicant: QUALCOMM Incorporated, San Diego, CA (US)

(72) Inventors: Rajapaksa Senaratne, San Diego, CA (US); Eunmo Kang, San Diego, CA (US); Koorosh Akhavan, San Diego, CA (US)

(21) Appl. No.: 15/255,783

(22) Filed: Sep. 2, 2016

Related U.S. Application Data
(60) Provisional application No. 62/314,721, filed on Mar. 29, 2016.

(51) Int. Cl. H04L 27/22; H04W 74/08; H04L 27/26

(52) U.S. Cl. CPC H04L 27/22; H04L 27/2601; H04W 74/0816

(57) ABSTRACT

Methods and systems for hardware-efficient carrier sensing are disclosed. The method may include receiving a received signal during a detection window, generating a phase-discriminated waveform based on the received signal, determining a plurality of absolute values respectively based on a plurality of correlations of the phase-discriminated waveform, and generating a detection metric based on a peak value of the plurality of absolute values.

### CROSS-REFERENCE TO RELATED APPLICATIONS

The present application for patent claims the benefit of U.S. Provisional Patent Application No. 62/314,721, entitled “CARRIER-SENSING METHOD FOR IEEE 802.15.4 O-QPSK PHY,” filed Mar. 29, 2016, pending, and assigned to the assignee hereof and hereby expressly incorporated herein by reference in its entirety.

### INTRODUCTION

Disclosed aspects relate to a hardware-efficient carrier-sensing method.

### BACKGROUND

There is always a need for reducing hardware and complexity in a system while optimizing performance, as well as reducing the computational and processing overhead in telecommunication systems. One area with special requirements that can prove burdensome to a system is carrier sensing. A Carrier Sensing Multiple Access with Collision Avoidance (CSMA-CA) protocol, for example, is a probabilistic media access control (MAC) protocol, where a node in a network verifies the absence of other data traffic, prior to transmitting on a shared communication medium, such as an electrical bus or a band of the electromagnetic spectrum that is used for communication.

In many conventional systems, there is one correlator used or dedicated to the processing of each distinct codeword that is used in implementing the communication protocol. For example, the offset quadrature phase shift keying (abbreviated as “O-QPSK”) PHY of the Institute of Electrical and Electronics Engineers (abbreviated as “IEEE”) Standard 802.15.4 (2011) for Low-Rate wireless Personal Area Networks (LR-WPANs) (hereinafter “15.4 Standard”) specifies a codebook that includes sixteen distinct codewords (hereinafter “15.4 codewords”). Conventionally, a device would require one dedicated correlator in order to sense each codeword in the 15.4 codebook, that is, sixteen correlators to sense all 15.4 codewords. This is an expensive and hardware-intensive solution associated with a high computational overhead penalty.

Accordingly, there is a need in the art, to avoid and circumvent the drawbacks of the above-described conventional approach.

### SUMMARY

Aspects of the invention are disclosed in the following description and related drawings directed to specific aspects of the invention.

In accordance with aspects of the disclosure, a method for hardware-efficient carrier sensing is provided. The method may include receiving a received signal during a detection window, generating a phase-discriminated waveform based on the received signal, determining a plurality of absolute values respectively based on a plurality of correlations of the phase-discriminated waveform, and generating a detection metric based on a peak value of the plurality of absolute values.

In accordance with other aspects of the disclosure, an apparatus for hardware-efficient carrier sensing is provided. The apparatus may include a receiver configured to receive a received signal during a detection window, a processor, and a memory coupled to the processor. The processor may be configured to generate a phase-discriminated waveform based on the received signal, determine a plurality of absolute values respectively based on a plurality of correlations of the phase-discriminated waveform, and generate a detection metric based on a peak value of the plurality of absolute values.

In accordance with yet other aspects of the disclosure, another apparatus for hardware-efficient carrier sensing is provided. The apparatus may include means for receiving a received signal during a detection window, means for generating a phase-discriminated waveform based on the received signal, means for determining a plurality of absolute values respectively based on a plurality of correlations of the phase-discriminated waveform, and means for generating a detection metric based on a peak value of the plurality of absolute values.

### BRIEF DESCRIPTION OF THE DRAWINGS

The accompanying drawings are presented to aid in the description of embodiments of the invention and are provided solely for illustration of the embodiments and not any limitations thereof.

FIG. 1 generally illustrates a wireless device in accordance with aspects of the disclosure.

FIG. 2 generally illustrates a wireless transceiver according to aspects of the disclosure.

FIG. 3 generally illustrates wireless devices in accordance with aspects of the disclosure.

FIG. 4 generally illustrates a Carrier Sense Multiple Access with Collision Avoidance (CSMA-CA) algorithm in accordance with aspects of the disclosure.

FIG. 5 generally illustrates the mapping of a stream of input bits to a stream of data symbols in accordance with aspects of the disclosure.

FIG. 6 generally illustrates a table for mapping of a respective data symbol to a series of chip values in accordance with aspects of the disclosure.

FIG. 7 generally illustrates a graph of the absolute value of a correlation of a phase-discriminated input to a selected codeword of a plurality of codewords.

FIG. 8 generally illustrates an apparatus for implementing a carrier-sensing method in accordance with aspects of the disclosure.

FIG. 9 generally illustrates a method for performing carrier-sensing in accordance with aspects of the disclosure.

### DETAILED DESCRIPTION OF THE INVENTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over the other embodiments. Likewise, the term “embodiments of the invention” does not require that all embodiments of the invention include the discussed feature, advantage or mode of operation

The terminology used herein is for the purpose of describing particular embodiments only and is not intended to be limiting of embodiments of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences, and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying the methods disclosed herein. Accordingly, the invention is not limited to illustrated examples, and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps, and/or actions of the method claims in accordance with the embodiments of the invention described herein need not be performed in any particular order. Furthermore, although elements of the invention may be described or claimed in the singular, the plural is contemplated unless limitation to the singular is explicitly stated.

Wireless personal area networks (WPANs) are used to convey information over relatively short distances. Unlike wireless local area networks (WLANs), connections effected via WPANs involve little or no supporting infrastructure. This feature allows small, power-efficient, and relatively inexpensive solutions to be implemented for a wide range of devices. The raw data rate is high enough (250 kb/s) to satisfy a set of applications. But it is also scalable down to the needs of sensor and automation needs (20 kb/s or below) for wireless communications. The 15.4 Standard, for example, may define the physical layer (PHY) and medium access control (MAC) sublayer specifications for low data rate wireless connectivity.

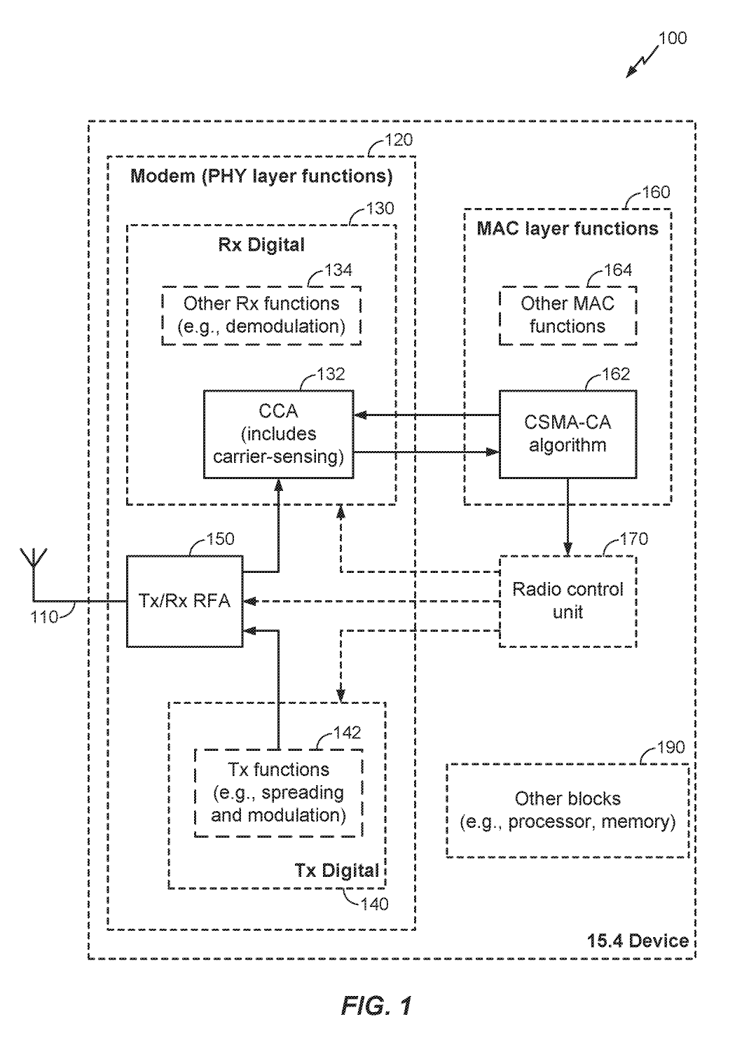

FIG. 1 generally illustrates a wireless device 100 in accordance with aspects of the disclosure.

The wireless device 100 may include an antenna 110 coupled to a modem 120. The modem 120 may perform physical (PHY) layer functions and may include a receiver 130, a transmitter 140, and a RF assembly 150. The wireless device 100 may further include a MAC module 160, a radio control unit 170, and other components 190, as will be discussed in greater detail below.

The receiver 130 may include a clear channel assessment module 132 and a receiver function module 134. The clear channel assessment module 132 may perform carrier-sensing functions. As will be discussed in greater detail below, the wireless device 100 may be configured to operate in accordance with the 15.4 Standard, which may require the wireless device 100 to determine that a particular channel is clear before transmitting on the particular channel. The determination may be referred to as a clear channel assessment (which may be abbreviated as “CCA”). The receiver function module 134 may include one or more components configured to perform other receiving functions associated with the receiver 130, for example, demodulation of signals received at the antenna 110.

The transmitter 140 may include a transmission function module 142. The transmission function module 142 may be configured to perform transmitting functions associated with the transmitter 140, for example, spreading and/or modulation of signals to be transmitted via the antenna 110.

The receiver 130 and transmitter 140 may each be coupled to the RF assembly 150. The RF assembly 150 may be configured to selectively couple the antenna 110 to the receiver 130 and/or the transmitter 140. The RF assembly 150 may also be configured to receive control signals from the radio control unit 170.

The MAC module 160 may include a CSMA-CA module 162 and a MAC function module 164. The CSMA-CA module 162 may interact with the radio control unit 170 to enable Rx/Tx Digital/RFA components if necessary. As will be discussed in greater detail below, the CSMA-CA module 162 may perform one or more algorithms associated with carrier sensing and/or collision avoidance, for example, a CSMA-CA protocol. For example, the CSMA-CA module 162 may exchange signals with the clear channel assessment module 132 of the receiver 130 in the modem 120. The signals may include, for example, instructions for performing carrier sensing sent from the CSMA-CA module 162 to the clear channel assessment module 132. The instructions to perform carrier sensing may specify, for example, a particular channel, a particular detection window, etc. The signals may further include, for example, carrier-sensing data that indicates, for example, an energy level associated with a particular channel. The signal may further include, for example, received signal data associated with a particular channel, codewords associated with the received signal data, and/or indications as to whether the received signal data has modulation and spreading characteristics associated with a particular standard (for example, the 15.4 Standard). The MAC function module 164 may include one or more components configured to perform other receiving functions associated with the MAC module 160, for example, miscellaneous MAC functions other than CSMA-CA.

The radio control unit 170 may be configured to control one or more components of the modem 120, for example, the receiver 130, the transmitter 140, and/or the RF assembly 150. For example, the radio control unit 170 may receive an indication from the CSMA-CA module 162 that a clear channel assessment has been performed and/or that a clear channel has been identified. The radio control unit 170 may be further configured to instruct the transmitter 140 and/or RF assembly 150 to transmit a signal and/or specify a channel (for example, an identified clear channel) upon which to perform the transmission.

The other components 190 may include other components necessary for the functioning of the wireless device 100, for example, a processor, a memory, a power unit, a user interface, etc. The various components of the wireless device 100 described above may be implemented using one or more processors, memories, and/or transceivers. For example, one or more processors and one or more memories coupled to the one or more processors may be used to implement one or more functions of one or more of the components of the wireless device 100.

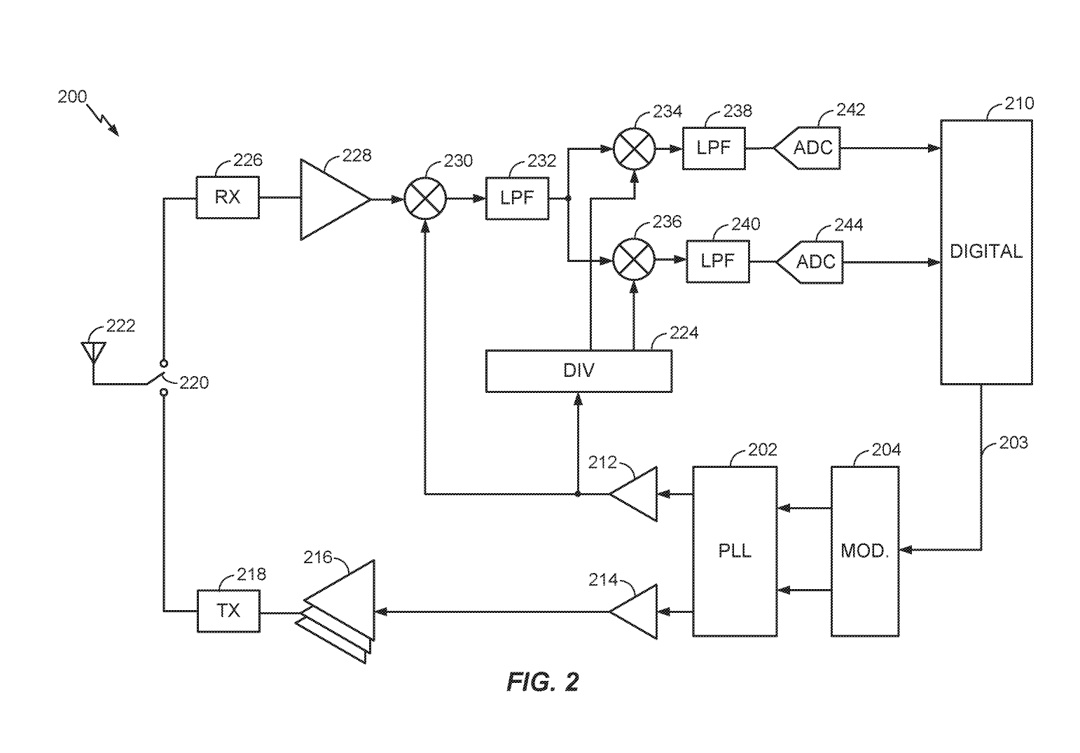

FIG. 2 generally illustrates a wireless transceiver 200 according to aspects of the disclosure. The wireless transceiver 200 may be analogous to one or more components of the wireless device 100 depicted in FIG. 1, for example, one or more components of the modem 120.

The illustrated example of wireless transceiver 200 includes PLL 202, modulator 204, digital controller 210, buffers 212 and 214, transmit amplifiers 216, transmit matching network 218, transmit/receive switch 220, antenna 222, divider 224, receive matching network 226, front end amplifier 228, mixer 230, low pass filter 232, mixers 234 and 236, low pass filters 238 and 240, and analog-to-digital converters (ADCs) 242 and 244.

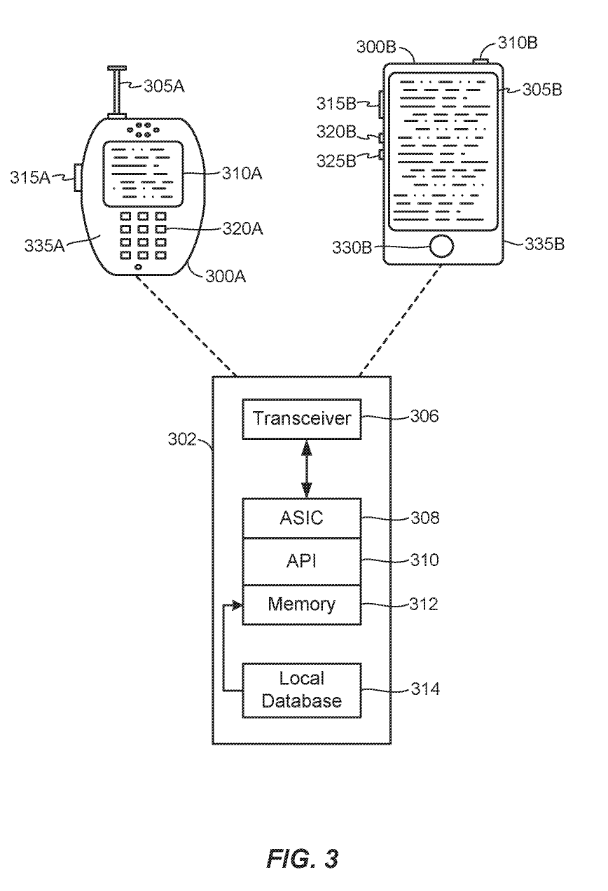

FIG. 3 generally illustrates wireless devices 300A and 300B in accordance with aspects of the disclosure. The wireless device 300A and/or the wireless device 300B may be analogous to the wireless device 100 depicted in FIG. 1. Moreover, the wireless devices 300A and 300B may include one or more components of the wireless transceiver 200 depicted in FIG. 2.

The example wireless device 300A is illustrated in FIG. 3 as a calling telephone and wireless device 300B is illustrated as a touchscreen device (e.g., a smart phone, a tablet computer, etc.). As shown in FIG. 3, an exterior housing 335A of wireless device 300A is configured with antenna 305A, display 310A, at least one button 315A (e.g., a PTT button, a power button, a volume control button, etc.) and keypad 320A among other components, not shown in FIG. 3 for clarity. An exterior housing 335B of wireless device 300B is configured with touchscreen display 305B, peripheral buttons 310B, 315B, 320B and 325B (e.g., a power control button, a volume or vibrate control button, an airplane mode toggle button, etc.), at least one front-panel button 330B (e.g., a Home button, etc.), among other components, not shown in FIG. 3 for clarity. For example, while not shown explicitly as part of wireless device 300B, wireless device 300B may include one or more external antennas and/or one or more integrated antennas that are built into the exterior housing 335B of wireless device 300B, including but not limited to WiFi antennas, cellular antennas, satellite position system (SPS) antennas (e.g., global positioning system (GPS) antennas), and so on.

While internal components of wireless devices such as the wireless devices 300A and 300B can be embodied with different hardware configurations, a basic high-level configuration for internal hardware components is shown as platform 302 in FIG. 3. Platform 302 can receive and execute software applications, data and/or commands transmitted from a radio access network (RAN) that may ultimately come from a core network, the Internet and/or other remote servers and networks (e.g., an application server, web URLs, etc.). Platform 302 can also independently execute locally stored applications without RAN interaction. Platform 302 can include a transceiver 306 operably coupled to an application specific integrated circuit (ASIC) 308, or other processor, microprocessor, logic circuit, or other data processing device. ASIC 308 or other processor executes an application programming interface (API) 310 layer that interfaces with any resident programs in a memory 312 of the electronic device. Memory 312 can be comprised of read-only or random-access memory (RAM and ROM), EEPROM, flash cards, or any memory common to computer platforms. Platform 302 also can include a local database 314 that can store applications not actively used in memory 312, as well as other data. Local database 314 is typically a flash memory cell, but can be any secondary storage device as known in the art, such as magnetic media, EEPROM, optical media, tape, soft or hard disk, or the like.

In one aspect, wireless communications by wireless devices 300A and 300B may be enabled by the transceiver 306 based on different technologies, such as Code Division Multiple Access (CDMA), Wideband Code Division Multiple Access (W-CDMA), Time Division Multiple Access (TDMA), Frequency Division Multiple Access (FDMA), Orthogonal Frequency Division Multiplexing (OFDM), Global System for Mobile (GSM), 2G, 3G, 4G, Long-Term Evolution (LTE), or other protocols that may be used in a wireless communications network or a data communications network. Voice and/or data can be transmitted to the electronic devices from a RAN using a variety of networks and configurations. Accordingly, the illustrations provided herein are not intended to limit the aspects of the invention and are merely to aid in the description of aspects of the invention.

Accordingly, aspects of the present disclosure can include a wireless device (e.g., wireless devices 300A, 300B, etc.) configured, and including the ability to perform the functions as described herein. For example, transceiver 306 may be implemented as wireless transceiver 200 of FIG. 2, including the transmit processing path. As will be appreciated by those skilled in the art, the various logic elements can be embodied in discrete elements, software modules executed on a processor, or any combination of software and hardware to achieve the functionality disclosed herein. For example, ASIC 308, memory 312, API 310, and local database 314 may all be used cooperatively to load, store, and execute the various functions disclosed herein, and thus the logic to perform these functions may be distributed over various elements. Alternatively, the functionality could be incorporated into one discrete component. Therefore, the features of the wireless devices 300A and 300B in FIG. 3 are to be considered merely illustrative, and the invention is not limited to the illustrated features or arrangement.

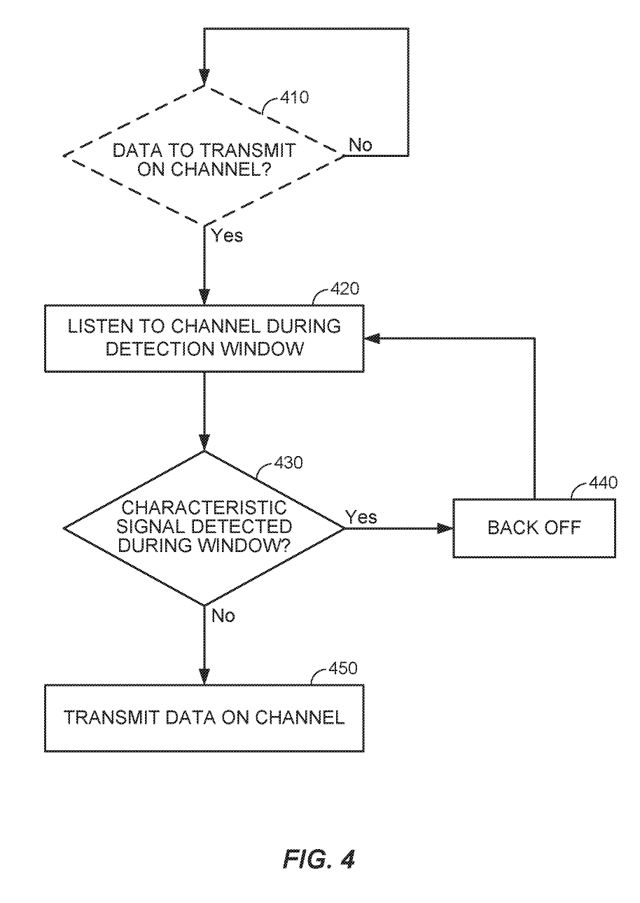

FIG. 4 generally illustrates a CSMA-CA algorithm 400 (wherein CSMA-CA is an abbreviation for Carrier Sense Multiple Access with Collision Avoidance) in accordance with aspects of the disclosure. The CSMA-CA algorithm 400 may be simplified for purposes of illustration. The CSMA-CA algorithm 400 may include a clear channel assessment. For example, the CSMA-CA algorithm 400 may rely on a clear channel assessment capability/function and may determine if no other transmission occupies a particular channel. The CSMA-CA algorithm 400 may be performed by, for example, the wireless device 100 depicted in FIG. 1 (for example, the CSMA-CA module 162 and/or the clear channel assessment module 132), the wireless device 300A and/or 300B depicted in FIG. 3, or any other suitable apparatus. For purposes of illustration, the CSMA-CA algorithm 400 will be described as it would be performed by the wireless device 100.

At 410, the wireless device 100 optionally determines whether there is data to be transmitted on a particular channel. In some implementations, the determining at 410 may be performed by the CSMA-CA module 162 depicted in FIG. 1. If, at 410, the wireless device 100 determines that there is data to be transmitted (‘yes’ at 410), then the CSMA-CA algorithm 400 may proceed to 420, as will be discussed in greater detail below. If, at 410, the wireless device 100 determines that there is not any data to be transmitted on the channel (‘no’ at 410), then the CSMA-CA algorithm 400 may continuously return to the determining at 410.

It will be understood that the determining at 410 may be omitted. As an alternative, the CSMA-CA algorithm 400 may proceed to 420 intermittently, for example, periodically.

At 420, the wireless device 100 listens to the channel during a detection window. The detection window may include, for example, a set period of time. The listening at 420 may include, for example, transmitting an instruction to listen to the channel during the detection window and may be performed by, for example, the CSMA-CA module 162 depicted in FIG. 1. Additionally or alternatively, the listening at 420 may include carrier sensing, detecting an energy level on the channel, or any other suitable listening in accordance with aspects of the disclosure, and may be performed by, for example, the clear channel assessment module 132 depicted in FIG. 1.

At 430, the wireless device 100 determines whether a characteristic signal is detected during the detection window. In some implementations, the characteristic signal may be a signal that is modulated and spread in accordance with a particular standard, for example, the 15.4 Standard. Accordingly, the wireless device 100 may identify one or more modulation and spreading characteristics of the signal and determine whether they match the modulation and spreading characteristics of the particular standard, for example, the 15.4 Standard. The determining at 430 may be performed by, for example, the clear channel assessment module 132 and/or the CSMA-CA module 162 depicted in FIG. 1.

If, at 430, the wireless device 100 determines that the characteristic signal is detected during the detection window (‘yes’ at 430), then the CSMA-CA algorithm 400 proceeds to 440. At 440, the wireless device 100 backs off the channel. The backing off at 440 may include waiting until a particular time and/or waiting for a particular duration of time. After the backing off at 440 is complete, the CSMA-CA algorithm 400 may return to the listening at 420.

If, at 430, the wireless device 100 determines that the characteristic signal is not detected during the detection window (‘no’ at 430), then the CSMA-CA algorithm 400 proceeds to 450. At 450, the wireless device 100 transmits data on the channel. The transmitting at 450 may include transmitting of the data determined at 410. The transmitting at 450 may include, for example, transmitting an instruction to transmit data to one or more of the transmitter 140, the RF assembly 150, and the radio control unit 170, and may be performed, for example, by the CSMA-CA module 162. Additionally or alternatively, the transmitting at 450 may include, for example, transmitting the data and may be performed, for example, by one or more of the antenna 110, the transmitter 140, and the RF assembly 150.

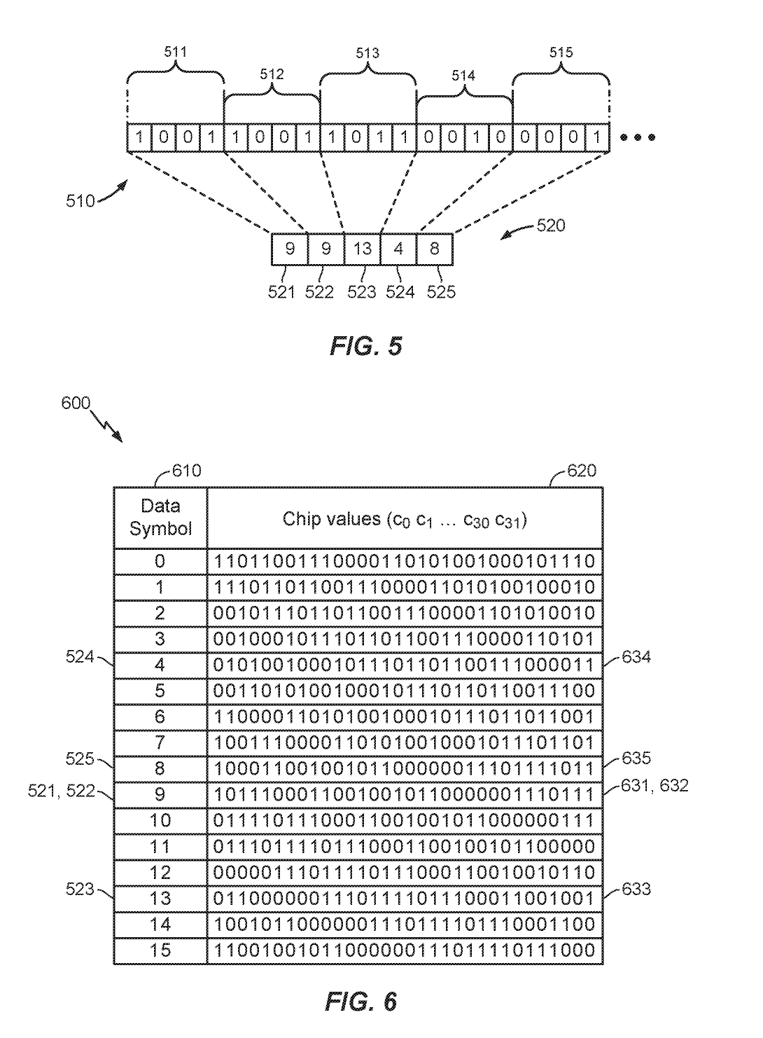

As noted above, identifying a characteristic signal may be expensive and hardware-intensive and may be associated with a high computational overhead penalty. For example, consider an implementation in which the wireless device 100 is performing the determining at 430 by receiving a signal and determining whether the received signal was transmitted in compliance with the 15.4 Standard. The wireless device 100 may perform the determining at 430 by analyzing the modulation and spreading characteristics of the received signal. To assist the reader in understanding how a 15.4 Standard-compliant signal may be recognized based on modulation and spreading characteristics, FIGS. 5-6 are provided.

FIG. 5 generally illustrates the mapping of a stream of input bits 510 to a stream of data symbols 520 in accordance with aspects of the disclosure.

As an example, a twenty-bit stream of input bits 510 is provided having the sequence “1001 1001 1011 0010 0001” (with spacing added between nibbles for ease of illustration). If, for example, the stream of input bits 510 were to be transmitted in accordance with the 15.4 Standard, the stream of input bits 510 would first be mapped to the stream of data symbols 520. In order to perform the mapping, the stream of input bits 510 would be divided into nibbles 511-515, each nibble consisting of four input bits. In particular, a first nibble 511 would consist of bits “1001,” a second nibble 512 would consist of bits “1001,” a third nibble 513 would consist of bits “1011,” a fourth nibble 514 would consist of bits “0010,” and a fifth nibble 515 would consist of bits “0001.” Then, each nibble would be converted to a data symbol. In the present illustration, the conversion is performed as specified in the 15.4 Standard, that is, by converting each nibble beginning with the least-significant bit (LSB) and proceeding to the most-significant bit (MSB). In particular, the first nibble 511 would be interpreted as binary “1001” and converted to a first data symbol 521 consisting of data symbol “9,” the second nibble 512 would be interpreted as binary “1001” and converted to a second data symbol 522 consisting of data symbol “9,” the third nibble 513 would be interpreted as binary “1101” and converted to a third data symbol 523 consisting of data symbol “13,” the fourth nibble 514 would be interpreted as binary “0100” and converted to a fourth data symbol 524 consisting of data symbol “4,” and the fifth nibble 515 would be interpreted as binary “1000” and converted to a fifth data symbol 525 consisting of data symbol “8.”

FIG. 6 generally illustrates a table 600 for mapping of a data symbol to a series of chip values in accordance with aspects of the disclosure. In some implementations, each series of chip values may be referred to as a “codeword” and the table 600 may be referred to as a “codebook.”

The table 600 of FIG. 6 includes a first column 610 that includes each of the sixteen data symbols “0”-“16” and a second column 620 that includes sixteen distinct codewords. In accordance with the 15.4 Standard, each 15.4 codeword may include thirty-two chip values (indexed from 0 to 31). However, other values are possible (for example, sixteen chip values indexed from 0 to 15), as are values associated with other technologies and/or standards. Accordingly, each data symbol in the stream of data symbols 520 may be mapped to a particular codeword using the table 600. The mapping of the stream of input bits 510 to the sequence of codewords 631-635 may be referred to as “spreading.”

The codewords shown in the second column 620 may be nearly-orthogonal pseudo-random noise sequences. For example, the first data symbol 521 consisting of data symbol “9” may be mapped to a first codeword 631 having the sequence of chip values “10111000110010010110000001110111,” the second data symbol 522 consisting of data symbol “9” may be mapped to a second codeword 632 having the sequence of chip values “10111000110010010110000001110111,” the third data symbol 523 consisting of data symbol “13” may be mapped to a third codeword 633 having the sequence of chip values “01100000011101111011100011001001,” the fourth data symbol 524 consisting of data symbol “4” may be mapped to a fourth codeword 634 having the sequence of chip values “01010010001011101101100111000011,” and the fifth data symbol 525 consisting of data symbol “8” may be mapped to a fifth codeword 635 having the sequence of chip values “10001100100101100000011101111011.” It will be understood that this is merely an example showing how the 15.4 Standard in particular might be recognized, and that the signal may include any other recognizable sequence in accordance with aspects of the disclosure.

Once the codewords 631-635 (and their respective sequences of chip values) have been determined, the chip values may be modulated onto a carrier. In the 15.4 Standard, the modulation includes offset quadrature phase shift keying (abbreviated as “O-QPSK”) with half-sine pulse shaping, wherein a “1” is represented by the first half of a sine wave (the positive half) and a “0” or “−1” is represented by the second half of the sine wave (the negative half). Even-indexed chips (c₀, c₂, c₄, etc.) are modulated onto the in-phase (I) carrier, and odd-indexed chips (c₁, c₃, c₅, etc.) are modulated onto the quadrature-phase (Q) carrier. To form the offset between I-phase and Q-phase chip modulation, the Q-phase chips may be delayed by one chip duration with respect to the I-phase chips.

Returning to FIG. 4, the question arises as to how the wireless device 100 is configured to determine (at 430) that a characteristic signal is detected during the detection window (of 420). Detection of the characteristic signal may indicate that the channel is not clear, and the wireless device 100 may observe the back-off period (as at 440). For example, transmission would be restricted at least until additional listening is performed. The wireless device 100 may only transmit data (at 450) if the characteristic signal is not detected during the detection window.

For example, in order to comply with the 15.4 Standard, the wireless device 100 must support a particular clear channel assessment (CCA) function. For example, in a carrier-sense based CCA mode associated with the 15.4 Standard, a channel is considered to be clear and safe to transmit data if the presence of a carrier modulated in accordance with the 15.4 Standard cannot be detected in the received signal during the detection window. It should be noted that 15.4 also supports multiple physical layer (PHY) formats, for example, O-QPSK PHY formats. The CSMA-CA algorithm allows you to back off on the transmission and try transmitting the information again (as at 440). The orthogonal quadrature phase-shift keying (O-QPSK) PHY of the IEEE 802.15.4 technology supports carrier sense mode of CCA, where “modulation and spreading characteristics of the PHY” form the signature that is used for detecting a 15.4 signal.

The conventional approach, which will be discussed in greater detail below, may have high costs in terms of space, production expense, and/or processing power. However, these costs may be advantageously reduced in accordance with aspects of the disclosure.

In the conventional approach, the wireless device 100 may include a 1:1 ratio of correlators to distinct codewords. For example, to determine if a particular channel is clear, the wireless device 100 must determine a correlation between the received signal (or portions thereof) and each of the sixteen different 15.4 codewords. If the received signal includes any sequence of 15.4 codewords during the detection window, the wireless device 100 must determine (at 430) that the channel is not clear, and observe the back-off period (as at 440). The wireless device 100 may only transmit data (at 450) if the signal portion does not correlate to any sequence of the sixteen 15.4 codewords. Given that the 15.4 Standard may specify a detection window with a duration of eight codewords (128 μs, with each 15.4 codeword having a duration of 16 μs), it will be understood that the wireless device 100 must be configured to recognize any one of 16⁸ (˜4.294×10⁹) possible codeword sequences. Moreover, for a single correlator operating at 8 MHz, one hundred and twenty-eight taps may be required for each 16 μs duration. Accordingly, the determining at 430, when performed using the conventional approach, may have high costs in terms of processing and/or power consumption. The present disclosure provides new techniques for reducing the amount of processing and/or power consumption necessary to perform clear channel assessment.

As will be understood from FIGS. 5-6, the IEEE 802.15.4 standard specifies that a carrier-sensing method is expected to detect the presence of a 15.4 carrier based on the received signal within an eight (8) nibble detection window. The 15.4 standard uses sixteen (16) codewords for spreading, and the carrier-sensing method should be able to detect any combination of the codewords in the eight (8) nibble detection window. Each nibble is mapped to a pseudo-noise (PN) “code sequence” or a “code word.” Codeword is more often used as it relates to channel coding.

In a spreading communication protocol (e.g. CDMA), the sequence is data independent. That is, the same sequence is used regardless of the transmitted bits. In this implementation, the term codeword is data dependent as in channel coding. That is, we have 16 possible sequences/codewords and pick one depending on the combination of each 4-bit group to be transmitted.

Note that a set of multiple codewords are referred to as a codebook. In one example, the codebook can be implemented in the form of a look-up table such as the table 600 depicted in FIG. 6. Another feature of the 802.15.4 O-QPSK PHY is that the codewords are correlated to each other and it is this correlation attribute that is utilized in implementing the different aspects of the present disclosure.

The codewords can be generated through cyclic shifting and bit inversion. For example, it will be observed from the table 600 depicted in FIG. 6 that the chip values c₀ through c₃ in the codeword “0” have the sequence “1101.” It will be further observed that for the codeword “1,” the sequence “1101” has been cyclically shifted to the right by four bits (to chip values c₄ through c₇), and that for the codeword “2,” the sequence “1101” has been cyclically shifted to the right by another four bits (to chip values c₈ through c₁₁). The cyclic shifting proceeds for all the codewords from codeword “0” through codeword “7,” at which point the “1101” sequence has shifted all the way to the end of the codeword (to chip values c₂₈ through c₃₁). The same cyclic shifting pattern can be observed for every chip value in the codewords “0” through “7.” The codewords “8” through “15” are identical to the codewords “0” through “7,” respectively, except that every odd-indexed chip value (c₁, c₃, c₅, etc.) is inverted. For example, the chip values c₀ through c₃ for the codewords “0” are “1101,” whereas the chip values c₀ through c₃ for the codewords “8” are “1000.” Note that chip values c₀ and c₂ (“1” and “0,” respectively) are the same for both of codeword “0” and codeword “8”. However, the chip values c₁ and c₃ are inverted. Because the chip sequences are related through cyclic shifting and inversion, the sixteen different 15.4 codewords are correlated. Aspects of the present disclosure leverage the observed correlation between the 15.4 codewords to reduce the processing necessary to perform a clear channel assessment.

Usually, spreading codes such as those described above with respect to FIG. 6 are designed to possess good autocorrelation and cross-correlation properties. The present techniques exploit certain characteristics of 15.4 codewords to achieve desired design objectives without adversely impacting the performance. However, those skilled in the art will appreciate that aspects of the present disclosure may also be applied and implemented to any existing and future technologies that exhibit similar correlation properties.

As mentioned earlier, the 15.4 Standard uses sixteen codewords (16). Carrier-sensing methods exploit the characteristics of the correlation of phase-discriminated waveforms corresponding to any pair of 15.4 codewords. One embodiment that will be discussed is a correlator matched to the 15.4 codeword zero (0).

The 15.4 PHY spreads the input bits by mapping each nibble to one of sixteen (16) 32-chip codewords. The codewords 1 through 7 are cyclic-shifted versions of codeword 0, where the shifting happens at multiples of four chips. Codewords 8 through 15 are related to codewords 0 through 7, respectively, through the inversion of odd-indexed chips.

Each nibble (i.e. a group of 4 bits) is mapped to 32 chips. The odd-indexed chips have odd indices if we indexed those chips from 0 to 31. These relationships produce a characteristics pattern in the cross-correlation between different codewords. The cyclic shifting causes the peaks of the cross-correlation to occur at delays of multiples of four chips (2 μs). The chip inversion results in similar cross-correlation, but with negative peaks (as opposed to positive peaks), when any codeword 0 through 7 is correlated with another codeword 8 through 15.

A 15.4 modulated waveform is a result of O-QPSK modulating and half-sine pulse shaping the outcome of the 15.4 spreading discussed above. This phase discrimination of the waveforms preserves the characteristic cross-correlation properties discussed above, if the phase discriminator uses samples that are one chip apart, for example, 0.5 μs apart. As will be discussed in greater detail below, the phase-discriminated waveform may be a product of a complex-valued received signal sample and the complex conjugate of a sample that preceded it by a fixed duration.

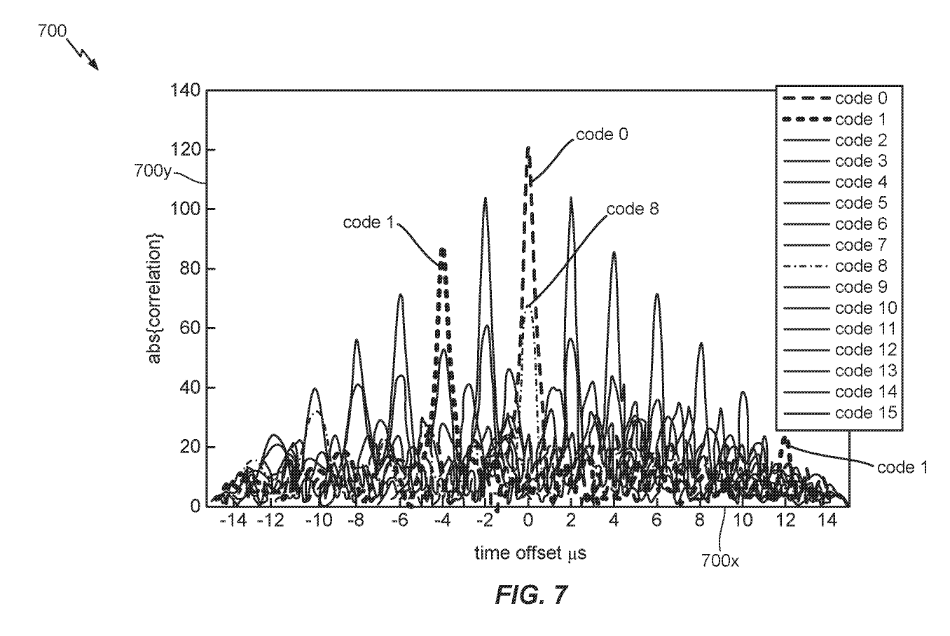

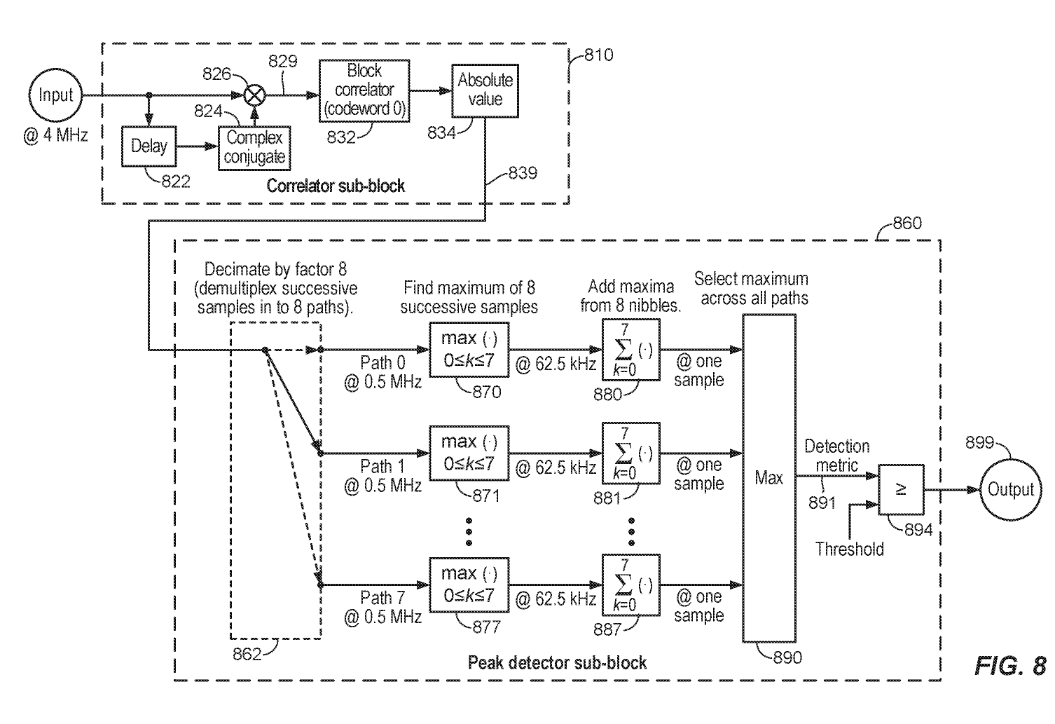

FIG. 7 generally illustrates a graph 700 of the absolute value of a correlation of a phase-discriminated input to a selected codeword of a plurality of codewords.

The plurality of codewords may constitute a codebook, wherein each codeword in the codebook corresponds to a particular data symbol. One or more pairs of codewords in the plurality of codewords may be related to one another based on cyclic shifting, bit inversion, or any combination thereof.

As noted above, the table 600 depicted in FIG. 6 shows an example codebook associated with the O-QPSK PHY of the IEEE Standard 802.15.4 (the “15.4 Standard”, as noted above). The codebook consists of sixteen codewords (“0” through “15”), each codeword consisting of thirty-two chip values. Each codeword in the table 600 is related to the other codewords based on cyclic shifting, bit inversion, or a combination thereof.

The graph 700 generally illustrates the absolute value of the correlation between each codeword in the example 15.4 Standard codebook and the particular codeword “0.” The horizontal axis 700x of the graph 700 depicts a time offset denoted in microseconds. The vertical axis 700y of the graph 700 depicts the absolute value of the correlation for each particular time offset. As will be understood from FIG. 7, each codeword in the example 15.4 Standard codebook correlates differently with codeword “0.”

Codewords “0” and “8” (labeled in FIG. 7 as “code 0” and “code 8,” respectively) produce only one peak at the output of a correlator matched to codeword “0.” The peak appears at time offset of 0 μm. All other codewords produce two peaks. For example, codeword “2” (labeled in FIG. 7 as “code 2”) has a first peak at −4 μs and a second peak at 12 μs. The peaks appear at regular intervals (offsets of 2 μs) due to the cyclic shifting of the plurality of codewords in the codebook.

FIG. 7 only shows the correlator output for isolated codewords, but in practice, the correlator input is a 15.4 waveform spanning multiple data nibbles, and the consequent inter-nibble interference at the correlator output suppresses some peaks and enhances some others. Even in this case, the peaks would occur at multiples of 2 μs apart, because each nibble-duration (16 μs) has a whole number of 2 μs durations.

FIG. 8 generally illustrates an apparatus 800 for implementing a carrier-sensing method in accordance with aspects of the disclosure. The apparatus 800 may be included in, for example, the clear channel assessment module 132 depicted in FIG. 1. However, it will be understood that one or more components of the apparatus 800 (or functions thereof) may be implemented on another component of the wireless device 100 depicted in FIG. 1. For example, one or more components of the apparatus 800 (or functions thereof) may be implemented using the receiver function module 134, the CSMA-CA module 162, etc.

The apparatus 800 receives an input 801 at a correlator module 810. The input 801 may be a received signal associated with a particular channel. As will be discussed in greater detail below, the correlator module 810 may be configured to generate a phase-discriminated waveform based on the received signal and determine a plurality of absolute values respectively based on a plurality of correlations of the phase-discriminated waveform. The plurality of absolute values generated by the correlator module 810 may be transmitted to a peak detector module 860, which may be configured to generate a detection metric based on one or more peak values of the plurality of absolute values. The detection metric may constitute an output of the apparatus 800.

The correlator module 810 may include a delay module 822, a complex conjugator 824, and a multiplier module 826. The delay module 822, the complex conjugator 824, and the multiplier module 826 may be used to generate a phase-discriminated waveform 829. In particular, the input 801 may provide a stream of data that includes a sequence of discrete samples. The input 801 may be, for example, a baseband signal sampled at a rate of 4 MHz (one sample every 0.25 μs). While new samples are provided at the input 801, a delay may be performed on a previous sample by the delay module 822. The previous sample may be delayed by, for example, once chip value relative to the new sample (0.5 μs in this example). The delay module 822 may include a delay line, i.e., a set of cascaded delays or a buffer containing 0.5 μs of samples (i.e., a buffer of two samples for an input rate of 4 MHz). The previous sample may be provided to the complex conjugator 824, which generates a complex conjugate of the previous sample. The complex conjugator 824 may then provide the complex conjugate to the multiplier module 826. The multiplier module 826 may multiply the new sample (provided at the input 801) by the complex conjugate of the previous sample (provided by the complex conjugator 824). The result of the multiplying may be referred to as a phase-discriminated waveform 829.

It will be understood that FIG. 8 illustrates a first example implementation of how the correlator module 810 generates the phase-discriminated waveform 829. However, the phase-discriminated waveform 829 may be generated in any suitable manner, at least two of which are described below.

In a second example implementation, the complex conjugator 824 may precede the delay module 822. In particular, a complex conjugate of the input 801 may be determined by the complex conjugator 824, the complex conjugate may be delayed by the delay module 822, and then the output of the delay module 822 may be provided to the multiplier module 826. As used herein, the term “delayed complex conjugate signal of the received signal” may broadly refer to a signal that is delayed and then complex-conjugated, or to a signal that is complex-conjugated and then delayed.

In a third example implementation, the complex conjugator 824 may operate ‘in parallel’ with the delay module 822. In particular, the input 801 may be provided to both the delay module 822 and the complex conjugator 824, and the respective outputs of the delay module 822 and the 824 may be provided to the multiplier module 826.

Accordingly, generating the phase-discriminated waveform may comprise multiplying the received signal by a delayed complex conjugate of the received signal (as in the first example implementation and the second example implementation), multiplying a delayed received signal by a complex conjugate of the received signal (as in the third example implementation), or any combination thereof.

The phase-discriminated waveform 829 may be provided to a block correlator 832. The block correlator 832 may correlate the phase-discriminated waveform 829 based on a particular codeword. For example, the block correlator 832 may determine a correlation between the phase-discriminated waveform 829 and a particular phase-discriminated waveform corresponding to the particular codeword. The correlation result may then be provided to an absolute value module 834, which determines an absolute value of the correlation result and provides a correlator module output 839.

As noted above, the input to the block correlator 832 may be the phase-discriminated waveform 829. The output of the block correlator 832 may peak when the input corresponds to the codeword to which the correlator is matched. To achieve this, the block correlator 832 may include an adder and coefficients that are matched to a particular phase-discriminated waveform corresponding to a particular codeword. The coefficients may be derived based on a binary chip sequence corresponding to the codeword, a half-sine pulse shaping function, a sample rate of the input 801 (e.g., 4 MHz), and/or a sample separation used for phase-discrimination. For example, in implementations configured to operate in accordance with the 15.4 Standard, the particular codeword used by the block correlator 832 may be the 15.4 codeword “0.” This scenario is depicted in FIG. 7, as noted above. The 15.4 Standard may specify a preamble comprising a sequence of eight occurrences of codeword “0.” Therefore, this correlator output is typically available as a byproduct of signal acquisition. It will be understood that selecting the 15.4 codeword “0” for use by the block correlator 832, processing overhead may be minimized, since the acquisition hardware can be shared to compute this correlation even when the acquisition engine is not enabled.

Accordingly, if the block correlator 832 is matched to the 15.4 codeword “0” and the phase-discriminated waveform 829 corresponds to any of sixteen different 15.4 codewords (codeword “0,” codeword “1,” codeword “2,” etc.), then the correlator module output 839 will resemble the peak or series of peaks that corresponds to that particular 15.4 codeword, as depicted in FIG. 7.

In some implementations, for example, implementations that include 15.4 codewords, the codeword may span 16 μs, i.e., sixty-four samples at 4 MHz. The samples may be linearly combined based on respective coefficients to compute an output sample. For every input sample provided to the block correlator 832, the block correlator 832 may provide an output sample. The block correlator 832 may be viewed as a filter since for every input sample, a correlation is recomputed. Because the input to correlator is the phase-discriminated waveform 829, correlator coefficients associated with the block correlator 832 should be set to match a phase-discriminated waveform of the codeword in concern. For example, the correlator coefficients may be derived based on the chip sequence corresponding to a particular 15.4 codeword, half-sine pulse shaping, sample rate and sample separation used for phase-discrimination.

The peak detector module 860 detects if the peaks of the correlator module output 839 are similar to the peaks that are characteristic of a 15.4 waveform. To perform this task, the peak detector module 860 receives the correlator module output 839 at a demultiplexer 862. The demultiplexer 862 may demultiplex the correlator module output 839 to a plurality of paths. For example, if there are N paths, then the demultiplexer 862 will provide the first sample to the first path, the second sample to the second path . . . the N^{th} sample to the N^{th} path, the (N+1)^{th} sample to the first path, etc.

In some implementations, the number of paths may be based on the sampling rate of the input 801 and the duration of the specified codeword. For example, a 15.4 codeword may have a duration of 16 μs and each path may gather samples at a spacing of 2 μs. Accordingly, the peak detector module 860 may include as many paths as are necessary to ensure that the samples in each path are 2 μs apart. That is, eight paths (N=8) are necessary if the input rate is 4 MHz (as depicted in FIG. 8), because 2 μs*4 MHz=8. Likewise, sixteen paths (N=16) are necessary if the input rate is 8 MHz, etc.

Each path within the peak detector module 860 may include a peak detector module and a peak summer module. For example, as depicted in FIG. 8, Path 0 may include a peak detector module 870 and a peak summer module 880, Path 1 may include a peak detector module 871 and a peak summer module 881, and Path 7 may include a peak detector module 877 and a peak summer module 887. Although Paths 2-6 are omitted from FIG. 8, it will be understood that each of the plurality of paths fed by the demultiplexer 862 may include analogous components that perform analogous processing. The processing performed for each of the plurality of paths will be described below as it would be performed by the peak detector module 870 and peak summer module 880 in Path 0.

The peak detector module 870 may receive a plurality of successive samples from the demultiplexer 862. After the plurality of successive samples are received, the peak detector module 870 may determine a peak value from among the plurality of successive samples.

In some implementations, the plurality of successive samples may be eight. For example, as will be understood from FIG. 7, the peak positions for the different codewords are separated by a 2 μs offset in some implementations of the 15.4 Standard. If the samples provided to the demultiplexer 862 are separated by 0.25 μs (as in a previous example), then every 8^{th} sample will be demultiplexed to a particular path (where the peak detector module 860 has eight paths). However, if the samples provided to the demultiplexer 862 were separated by 0.125 μs (as in another example, where the peak detector module 860 has sixteen paths), then every 16^{th} sample will be demultiplexed to a particular path.

As noted above, each path depicted in FIG. 8 will receive samples that are separated by 2 μs. In order to cover each of the peak positions depicted in FIG. 7, the plurality of successive samples may be set to eight, such that the samples received every 2 μs from the demultiplexer 862 cover a total duration of 16 μs. The total duration of 16 μs will therefore cover a range of possible peak positions, for example, possible peak positions at offsets of 0 μs, 2 μs, 4 μs, 6 μs, 8 μs, 10 μs, 12 μs, and 14 μs. As will be understood from FIG. 7, at least one peak for each 15.4 codeword will be positioned within the 16 μs window associated with a particular path.

After receiving the plurality of successive samples, the peak detector module 870 may determine a peak value from among the plurality of successive samples. After the peak value has been determined by the peak detector module 870, the peak detector module 870 may provide the peak values to the peak summer module 880.

To return to an earlier example in which the plurality of successive samples include eight samples collected at 2 μs intervals, it will be understood that the peak detector module 870 may provide a peak value to the peak summer module 880 once very 16 μs (i.e., at a rate of 62.5 kHz). It will be observed that, in this scenario, the peak detector module 870 effectively obtains the value of the peak within a window that corresponds to the duration of a codeword and/or a nibble.

As noted above, the peak detector module 870 may be configured to provide a peak value to the peak summer module 880. As noted above, a peak value may be provided every 16 μs in some implementations. The peak summer module 880 may be configured to receive a plurality of successive peak values and compute a sum of the plurality of successive peak values. The sum computed by the peak summer module 880 may be provided to the all-path peak detector module 890.

As noted above, in some implementations of the 15.4 Standard, the detection window associated with the clear channel assessment has a duration equal to the total duration of eight codewords, for example, 128 μs. Moreover, a peak value may be provided by the peak detector module 870 at 16 μs intervals, i.e., the duration associated with one codeword. Accordingly, the number of peak values to be summed by the peak summer module 880 may be set to eight. Therefore, the peak summer module 880 may be configured to compute the sum of the eight peak values received from the peak detector module 870 during the previous eight nibble durations, i.e., the previous 128 μs.

As noted above, each path may receive demultiplexed samples that correspond to the separation between peak positions associated with the different codewords. For example, as will be understood from FIG. 7, the peak positions for the different codewords may be separated by a 2 μs offset in some implementations of the 15.4 Standard. Accordingly, Path 0 may receive a first sample of a plurality of samples at an offset time of 0 μs, a second sample at an offset time of 2 μs, a third sample at an offset time of 4 μs, etc. However, it will be further understood that the samples received on a different path, for example, Path 1, may not correspond to peak positions. For example, Path 1 may receive the first sample at an offset time of 0.25 μs, the second sample at an offset time of 2.25 μs, the third sample at an offset time of 4.25 μs, etc. As will be understood from FIG. 7, the values computed at these particular offset times on Path 1 may not correspond to peak values.

The apparatus 800 may not be configured to recognize ex ante which path of the plurality of paths includes the peak values. Therefore, the all-path peak detector module 890 is provided to determine the peak value of the sums computed over all the paths (Path 0, Path 1, etc.). The peak summer modules 880, 881, 887 (etc.) may each compute a sum for their respective paths and provide the sums to the all-path peak detector module 890. The all-path peak detector module 890 may determine the greatest of the sums and generate a detection metric 891.

The detection metric 891 represents a sum of the peaks when the input is a signal having modulation and spreading characteristics associated with a particular standard (for example, the 15.4 Standard). Generally, the detection metric 891 is large (i.e., greater than a detection threshold value) if the particular modulation and spreading characteristics are detected and significantly smaller (i.e., less than the detection threshold value) in the absence of these particular modulation and spreading characteristics. In order to determine whether the particular signal has been detected, the detection metric 891 is provided to a comparator 894, which determines whether the detection metric 891 exceeds the detection threshold value. If the detection metric 891 exceeds the detection threshold value, then the output 899 of the apparatus 800 will indicate that a characteristic signal has been detected, and if the detection metric 891 does not exceed the detection threshold value, then the output 899 will indicate that the characteristic signal has not been detected. As will be understood by returning to FIG. 4, the output 899 may be used to facilitate the determining at 430 as to whether the characteristic signal is detected during the detection window. The detection threshold may be an adaptive threshold that is dynamically calculated or it may be a fixed or preset value and is based upon the received signal level.

The components and functions represented by FIG. 8, as well as other components and functions described herein, may be implemented using any suitable means. Such means also may be implemented, at least in part, using corresponding structure as taught herein. For example, means for receiving a received signal during a detection window may correspond at least in some aspects to, for example, the antenna 110 and/or the receiver 130 depicted in FIG. 1. Means for generating a phase-discriminated waveform based on the received signal may correspond at least in some aspects to, for example, the clear channel assessment module 132, the CSMA-CA module 162 and/or the correlator module 810 depicted in FIGS. 1 and 8. Means for determining a plurality of absolute values respectively based on a plurality of correlations of the phase-discriminated waveform may correspond at least in some aspects to, for example, the clear channel assessment module 132, the CSMA-CA module 162 and/or the block correlator 832 depicted in FIGS. 1 and 8. Means for generating a detection metric based on one or more peak values of the plurality of absolute values may correspond at least in some aspects to, for example, the clear channel assessment module 132, the CSMA-CA module 162 and/or the peak detector module 860 depicted in FIGS. 1 and 8.

Means for delaying and determining a complex conjugate of the received signal to generate a delayed complex conjugate signal may correspond at least in some aspects to, for example, the delay module 822 and complex conjugator 824 depicted in FIG. 8. Means for multiplying the received signal by the delayed complex conjugate signal may correspond at least in some aspects to, for example, the multiplier module 826 depicted in FIG. 8. Moreover, the components described above in conjunction with FIG. 8 also may correspond to similarly designated “code for” functionality. Thus, in some aspects one or more of such means may be implemented using one or more of processor components, integrated circuits, or other suitable structure as taught herein.

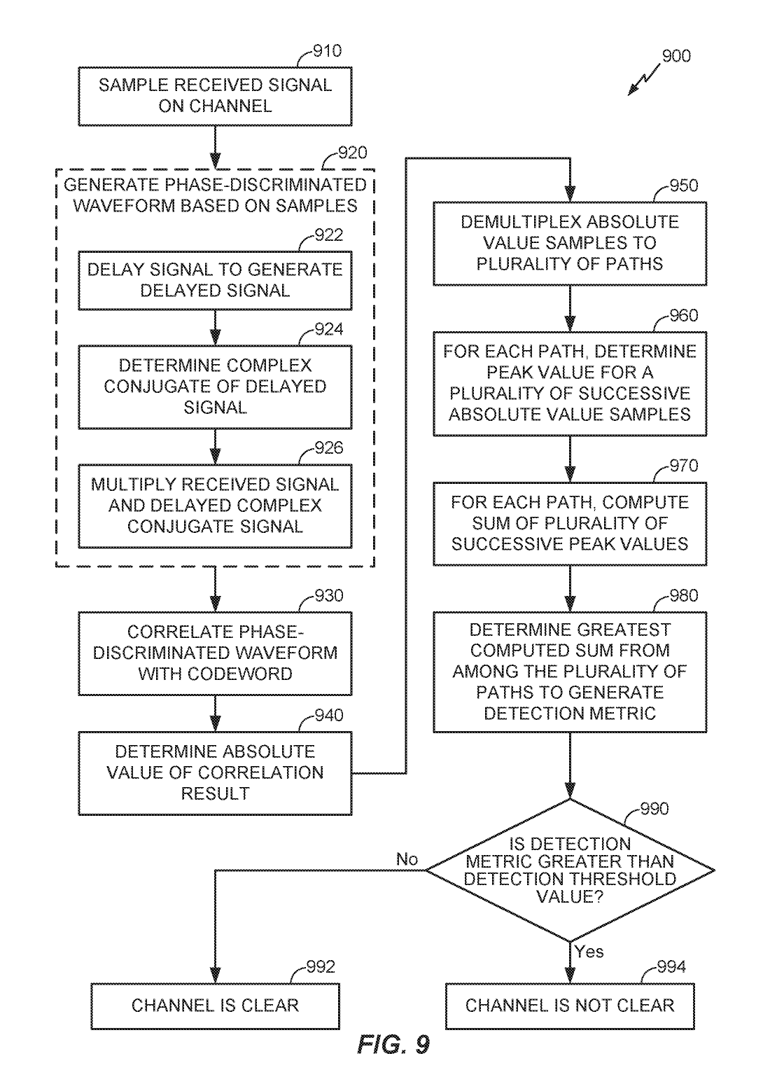

FIG. 9 generally illustrates a method 900 for performing carrier-sensing in accordance with aspects of the disclosure. The method 900 will be described below as it would be performed by the wireless device 100 depicted in FIG. 1 and/or the apparatus 800 depicted in FIG. 8, however, it will be understood that the method 900 may be performed by any suitable apparatus.

At 910, the method 900 samples a received signal on a channel. For example, the wireless device 100 may receive a signal at the antenna 110 and sample the received signal using the RF assembly 150 and/or the receiver 130. The sampling rate may be, for example, 4 MHz. The sampled signal from 910 may be provided as an input to, for example, the clear channel assessment module 132 depicted in FIG. 1. Additionally or alternatively, the input 801 depicted in FIG. 8 may be constituted by the sampled signal from 910. The input 801 may be provided to the correlator module 810 depicted in FIG. 8, which may perform the actions described below with respect to 920-940.

At 920, the method 900 generates a phase-discriminated waveform. The generating at 920 may be performed, for example, by the correlator module 810 depicted in FIG. 8. The phase-discriminated waveform may be analogous to the phase-discriminated waveform 829 depicted in FIG. 8. The generating at 920 may be performed as described below at 922-926.

At 922, the method 900 delays the signal provided at 910 to generate a delayed signal. The delaying at 922 may be performed, for example, by the delay module 822 depicted in FIG. 8.

At 924, the method 900 determines a complex conjugate of the delayed signal. The complex conjugate determining at 924 may be performed, for example, by the complex conjugator 824 depicted in FIG. 8.

Although the delaying at 922 precedes the determining of the complex conjugate at 924 as depicted in FIG. 9, it will be understood that in other implementations, the determining of the complex conjugate at 924 may precede the delaying at 922. In particular, a complex conjugate of the input 801 may be determined as at 924, the complex conjugate may be delayed as at 922, and then the result of the delaying as at 922 may be provided.

At 926, the method 900 multiplies the received signal and the delayed complex conjugate signal. The product multiplying at 926 may be performed, for example, by the multiplier module 826 depicted in FIG. 8. For example, a portion of the received signal sampled at 910 may be multiplied at the multiplier module 826 by a complex conjugate of delayed version of the received signal sampled at 910, wherein the complex conjugate of the delayed version is provided by the delay module 822 and the complex conjugator 824. The multiplying at 926 may generate a phase-discriminated waveform that equals the product of the received signal (sampled at 910) and the complex conjugate of the delayed signal (determined at 924).

At 930, the method 900 correlates the phase-discriminated waveform with a codeword. The correlating at 930 may be performed, for example, by the block correlator 832 depicted in FIG. 8 using the phase-discriminated waveform 829 provided by the multiplier module 826. The codeword may be preselected or dynamically selected. The codeword may be based on, for example, a binary sequence defined by a particular standard, as well as a half-sine pulse shaping function, a sample rate of the input 801, and/or a sample separation used for phase-discrimination, as noted above. In some implementations, the codeword may be selected from the table 600 of 15.4 codewords depicted in FIG. 6. In some implementations, the codeword may be the 15.4 codeword corresponding to data symbol “0,” as depicted in the first row of the table 600. As noted above, conventional techniques may require a unique correlator corresponding to each codeword. However, in accordance with aspects of the disclosure, the apparatus 800 may include fewer correlators than codewords (for example, the single block correlator 832 depicted in FIG. 8 may be sufficient for carrier-sensing in accordance with the 15.4 Standard having sixteen codewords).

At 940, the method 900 determines an absolute value of the correlation result. The absolute value determining at 940 may be performed by the absolute value module 834 depicted in FIG. 8 using the correlation result provided by the block correlator 832. The absolute value generated at 940 may constitute the correlator module output 839 depicted in FIG. 8. The correlator module output 839 may be provided to the peak detector module 860 depicted in FIG. 8, which may perform the actions described below with respect to 950-990. An absolute value sample may be determined at the same sampling rate as the sampling of the received signal performed at 910, for example, 4 MHz.

At 950, the method 900 demultiplexes the absolute value samples to a plurality of paths. The demultiplexing at 950 may be performed, for example, by the demultiplexer 862 depicted in FIG. 8. The demultiplexing at 950 may include demultiplexing a first absolute value sample to a first path, a second absolute value sample to a second path, etc. The demultiplexing at 950 may further include demultiplexing an N^{th} absolute value sample to an N^{th} path, a (N+1)^{th} absolute value sample to the first path, etc. For each path, absolute value samples may be provided by the demultiplexer 862 at a rate of, for example, 0.5 MHz.

At 960, the method 900 determines, for each path, a peak value for a plurality of successive absolute value samples. The peak value determining at 960 may be performed, for example, by a plurality of peak detector modules, each peak detector module being associated with a different path of the plurality of paths. The peak detector modules may be analogous to the peak detector modules 870, 871, 877 depicted in FIG. 8. The peak value determined at 960 may be provided by a particular peak detector module (for example, the peak detector module 870) to a peak summer module on the same path (for example, the peak summer module 880). For each path, peak values may be provided by the peak detector module 870 at a rate of, for example, 62.5 kHz.

At 970, the method 900 computes, for each path, a sum of a plurality of successive peak values. The computing at 970 may be performed, for example, by a plurality of peak summer modules, each peak summer module being associated with a different path of the plurality of paths. The peak summer modules may be analogous to the peak summer modules 880, 881, 887 depicted in FIG. 8. The sums computed at 960 may be provided by a particular peak summer module to the all-path peak detector module 890 depicted in FIG. 8.

At all-path determining at 980, the method 900 determines a greatest computed sum from among the plurality of paths to generate a detection metric. The all-path determining at 980 may be performed, for example, by the all-path peak detector module 890 depicted in FIG. 8. The detection metric generated at 980 may be analogous to the detection metric 891 depicted in FIG. 8.

At 990, the method 900 compares the detection metric against a detection threshold value to determine if the detection metric is greater than the detection threshold value. The threshold value comparison at 990 may be performed, for example, by the comparator 894 depicted in FIG. 8. The result of the comparison may be, for example, a binary outcome. The binary outcome may be provided as the output 899 depicted in FIG. 8. The output 899 may be used by, for example, the wireless device 100 to perform a clear channel assessment (CCA) as part of a CSMA-CA algorithm.

For example, if the detection metric is less than the detection threshold value (‘no’ at 990), then the wireless device 100 may determine at 992 that the channel upon which the signal was received (at 910) is clear. By contrast, if the detection metric is greater than the detection threshold value (‘yes’ at 990), then the wireless device 100 may determine at 994 that the channel upon which the signal was received (at 910) is busy or not clear.

While the foregoing disclosure shows illustrative aspects of the disclosure, it should be noted that various changes and modifications could be made herein without departing from the scope of the invention as defined by the appended claims. The functions, steps, and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method comprising:
receiving a received signal during a detection window;
generating a phase-discriminated waveform based on the received signal;
determining a plurality of absolute values respectively based on a plurality of correlations of the phase-discriminated waveform; and
generating a detection metric based on one or more peak values of the plurality of absolute values.

2. The method of claim 1, wherein generating the phase-discriminated waveform comprises:
multiplying the received signal by a delayed complex conjugate of the received signal;
multiplying a delayed received signal by a complex conjugate of the received signal; or
any combination thereof.

3. The method of claim 2, wherein the delaying of the received signal comprises delaying the received signal for 0.5 microseconds.

4. The method of claim 1, wherein determining each absolute value of the plurality of absolute values comprises:
correlating the phase-discriminated waveform based on a codeword; and
determining the absolute value of the correlation result.

5. The method of claim 4, wherein the codeword is a first codeword selected from a codebook, the codebook further comprising a second codeword, the first codeword and the second codeword being related based on cyclic shifting, bit inversion, or any combination thereof.

6. The method of claim 5, wherein the codebook is specified in Institute of Electrical and Electronics Engineers (IEEE) Standard 802.15.4.

7. The method of claim 4, wherein the codeword includes thirty-two chip values and corresponds to data symbol “0” as specified in Institute of Electrical and Electronics Engineers (IEEE) Standard 802.15.4.

8. The method of claim 4, wherein the correlating is performed by a single correlator.

9. The method of claim 1, wherein generating a detection metric comprises:
demultiplexing each absolute value of the plurality of absolute values to a path of a plurality of paths;
for each path, determining a peak value for a plurality of successive absolute values;
for each path, computing a sum of a plurality of successive peak values;
determining a greatest computed sum from among the plurality of paths; and
comparing the greatest computed sum to a detection threshold value.

10. The method of claim 9, further comprising performing a clear channel assessment based on the detection metric by determining that a channel upon which the received signal was received is clear in response to a determination that the greatest computed sum is less than the detection threshold value.

11. The method of claim 9, further comprising performing a clear channel assessment based on the detection metric by determining that the channel upon which the received signal was received is not clear in response to a determination that the greatest computed sum is greater than the detection threshold value.

12. The method of claim 9, wherein:
the plurality of paths consists of eight paths;
the plurality of successive absolute values consists of eight successive absolute values; and
the plurality of successive peak values consist of eight successive peak values.

13. The method of claim 1, further comprising determining to transmit data on a channel, wherein:
the received signal is received on the channel during the detection window in response to the determination to transmit data on the channel; and
a duration of the detection window is selected in accordance with a Carrier Sensing Multiple Access with Collision Avoidance (CSMA-CA) protocol.

14. The method of claim 13, further comprising:
performing a clear channel assessment of the channel based on the detection metric in accordance with the CSMA-CA protocol;
backing off the channel in response to a determination that the channel is not clear; and
transmitting the data on the channel in response to a determination that the channel is clear.

15. An apparatus comprising:
a receiver configured to receive a received signal during a detection window;
a processor; and
a memory coupled to the processor;
wherein the processor is configured to:
generate a phase-discriminated waveform based on the received signal;
determine a plurality of absolute values respectively based on a plurality of correlations of the phase-discriminated waveform; and
generate a detection metric based on one or more peak values of the plurality of absolute values.

16. The apparatus of claim 15, wherein to generate the phase-discriminated waveform, the processor is further configured to:
multiply the received signal by a delayed complex conjugate of the received signal;
multiply a delayed received signal by a complex conjugate of the received signal; or
any combination thereof.

17. The apparatus of claim 15, wherein to determine each absolute value of the plurality of absolute values, the processor is further configured to:
correlate the phase-discriminated waveform based on a codeword; and
determine the absolute value of the correlation result.

18. The apparatus of claim 15, wherein to generate the detection metric, the processor is further configured to:
demultiplex each absolute value of the plurality of absolute values to a path of a plurality of paths;
for each path, determine a peak value for a plurality of successive absolute values;
for each path, compute a sum of a plurality of successive peak values;
determine a greatest computed sum from among the plurality of paths; and
compare the greatest computed sum to a detection threshold value.

19. An apparatus comprising:
means for receiving a received signal during a detection window;
means for generating a phase-discriminated waveform based on the received signal;
means for determining a plurality of absolute values respectively based on a plurality of correlations of the phase-discriminated waveform; and
means for generating a detection metric based on one or more peak values of the plurality of absolute values.

20. The apparatus of claim 19, wherein means for generating the phase-discriminated waveform comprises:
means for multiplying the received signal by a delayed complex conjugate of the received signal;
means for multiplying a delayed received signal by a complex conjugate of the received signal; or
any combination thereof.
